(19) United States
(12) Patent Application Publication
(10) Pub. No.: US 2025/0153590 A1
(43) Pub. Date: May 15, 2025

(54) MOBILE CHARGING SYSTEM FOR ELECTRIC VEHICLES

(71) Applicant: Moog Inc., East Aurora, NY (US)

(72) Inventors: Eric J. Connor, Austin, TX (US); Greg Semrau, Amherst, NY (US)

(21) Appl. No.: 18/837,940

(22) PCT Filed: Feb. 13, 2023
(86) PCT No.: PCT/US2023/012915

§ 371 Date: Aug. 13, 2024

Related U.S. Application Data
(60) Provisional application No. 63/311,398, filed on Feb. 17, 2022.

(51) Int. Cl. B60L 53/57; B60L 53/10; B60L 53/53; B60L 53/54

(52) U.S. Cl. CPC B60L 53/57; B60L 53/11; B60L 53/53; B60L 53/54

(57) ABSTRACT

A mobile charging system comprising a mobile platform configured to be readily moved from a first location to a second location, an ammonia storage tank supported by the mobile platform, an ammonia cracker connected to the storage tank and supported by the mobile platform, a hydrogen fuel cell connected to the ammonia cracker and supported by the mobile platform, an electric storage connected to the hydrogen fuel cell and supported by the mobile platform, charging electronics connected to the electric storage and supported by the mobile platform, and at least one DC to DC electronic charging port supported by the mobile platform and configured to connect to the charging port of an electric vehicle.

### TECHNICAL FIELD

The presently disclosed subject matter relates generally to electric vehicle charging, and more particularly to a mobile electric charging system.

### BACKGROUND

US Patent Application Publication No. 2020/0376975, entitled “System for Charging a Battery Electric Vehicle or a Plugin Hybrid Vehicle Using a Mobile Fuel Cell,” is directed to a mobile fuel cell system having a fuel cell generator disposed on a mobile platform. US Patent Application Publication No. 2019/0359075, entitled “Fuel Cell Based Electric Vehicle DC Fast Charging System and Fuel Cell Based Electric Energy Storage,” is directed to a hydrogen fuel cell based electric vehicle DC fast charging system. U.S. Pat. No. 10,507,733, entitled “Energy Supply Vehicle for Supplying an Electrically Drivable Motor Vehicle with Electrical Energy,” is directed to a self-driving or remotely controlled energy supply vehicle. U.S. Pat. No. 10,207,592, entitled “Autonomous Hybrid Power Generation Platform,” is directed to a power generation platform for delivering power to an external load that includes an electrical system mounted to an autonomously-controlled chassis. US Patent Application Publication No. 2021/0155108, entitled “Mobile Charging Stations with Fuel-Cell Generators for Electric-Drive Vehicles,” is directed to deployable mobile charging stations for recharging electric-drive vehicles. US Patent Application Publication No. 2020/0403258, entitled “Ammonia Fuel Cell System and Electric Device,” is directed to an ammonia fuel cell system. US Patent Application Publication No. 2009/0304574, entitled “Configurations and Methods of Hydrogen Fueling,” is directed to automobile filing stations that receive liquid ammonia and in which hydrogen is produced by catalytic cracking. Each of the forgoing patent publications are incorporated in their entirety herein by reference.

### BRIEF SUMMARY

With parenthetical reference to corresponding parts, portions, or surfaces of the disclosed embodiment, merely for the purposes of illustration and not by way of limitation, the present disclosure provides a mobile charging system (15, 115) comprising: a mobile platform (20, 20a, 20b) configured to be readily moved from a first location to a second location; an ammonia storage tank (25) having a fuel inlet (26) and supported by the mobile platform; an ammonia cracker (30) connected to the storage tank and supported by the mobile platform; a hydrogen fuel cell (40) connected to the ammonia cracker and supported by the mobile platform; an electric storage (50) connected to the hydrogen fuel cell and supported by the mobile platform; charging electronics (60) connected to the electric storage and supported by the mobile platform; and at least one DC to DC electronic charging port (70, 75) supported by the mobile platform and configured to connect to a charging port (90, 91) of an electric vehicle (18).

The electric storage may comprise a battery. The charging electronics may be configured to provide DC Level 3 charging (70). The charging electronics may be configured to provide AC power and the system may comprise at least one AC to AC electronic port (80) supported by the mobile platform and configured to connect to the power port (92) of an AC load (19, 19a, 19b, 19c). The AC load may be selected from a group consisting of an office trailer (19a), a welding machine, a power tool, and a lighting device (19b). The AC load may be a converter (93) to a battery (94).

The mobile platform may be selected from a group consisting of a trailer, a truck chassis, a flatbed, a railway car, a skid platform (20b), and a detachable pod. The mobile platform may comprise a construction vehicle (20a) and the construction vehicle may be selected from a group consisting of a backhoe, an excavator (20a), a bulldozer, a skid steer loader, and a dump truck.

The electric vehicle may comprise an electric mobile machine (18a) and the electric mobile machine may be selected from a group consisting of a backhoe, an excavator, a bulldozer, a skid steer loader (18a), and a dump truck.

The mobile charging system may comprise an on-site bulk ammonia storage tank (55) separate from the ammonia storage tank (25) supported by the mobile platform, and the bulk ammonia storage tank may have a bulk fuel inlet (56) and a bulk fuel outlet (57) configured to connect to the fuel inlet (26) of the ammonia storage tank (25) supported by the mobile platform. The mobile charging system may comprise: a mobile refueling platform (60) configured to be readily moved from a first location to a second location; a mobile refueling ammonia storage tank (65) supported by the mobile refueling platform; the mobile refueling ammonia storage tank separate from both the ammonia storage tank supported by the mobile platform and the bulk ammonia storage tank; and the mobile refueling ammonia storage tank having a refueling fuel inlet (66) configured to connect to the bulk fuel outlet of the bulk ammonia storage tank and a refueling fuel outlet (67) configured to connect to the fuel inlet of the ammonia storage tank supported by the mobile platform.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 is a general schematic view of an embodiment of an improved mobile charging system.

FIG. 2 is an operative schematic view of a specific embodiment of the mobile platform and electric vehicle shown in FIG. 1.

FIG. 3 is an operative schematic view of an alternative specific embodiment of the mobile platform shown in FIG. 2 with an on-site bulk storage tank.

FIG. 4 is an operative schematic view of the specific embodiments of the mobile platforms shown in FIGS. 2 and 3 with an on-site bulk storage tank.

FIG. 5 is a general schematic view of an alternative embodiment of the mobile charging system shown in FIG. 1.

FIG. 6 is an operative schematic view of a specific embodiment of the mobile platform and AC load shown in FIG. 5.

FIG. 7 is an operative schematic view of an alternative specific embodiment of the AC load shown in FIG. 6.

FIG. 8 is an operative schematic view of an alternative specific embodiment of the mobile platform and AC load shown in FIG. 6.

FIG. 9 is an operative schematic view of the embodiment of the mobile platform shown in FIGS. 2 and 4 with an on-site bulk storage tank and on-site mobile refueling platform and tank.

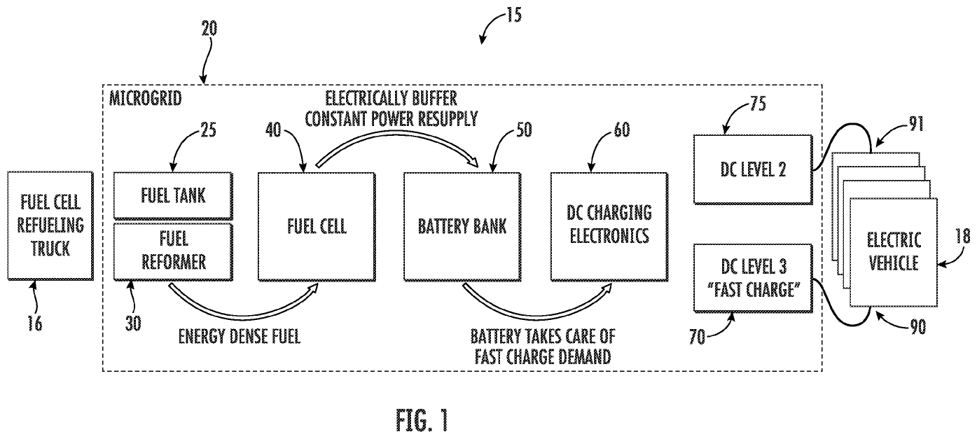

### DETAILED DESCRIPTION OF THE EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

It is to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application. It is to be appreciated that the present teaching is by way of example only, not by limitation. Where they are used herein, the terms “first,” “second,” and so on, do not necessarily denote any ordinal, sequential, or priority relation, but are simply used to distinguish one element or set of elements more clearly from another, unless specified otherwise.

An improved mobile fuel cell charging system for providing a charge to an electric vehicle is provided, a first embodiment of which is generally indicated at 15. As shown, mobile charging system 15 generally includes mobile platform 20 configured to be readily moved from a first location to a second location, liquid ammonia fuel storage tank 25 having fuel inlet 26 and supported by mobile platform 20, ammonia cracker 30 connected to ammonia fuel storage 25 and supported by mobile platform 20, hydrogen fuel cell 40 connected to ammonia cracker 30 and supported by mobile platform 20, battery bank 50 connected to hydrogen fuel cell 40 and supported by mobile platform 20, DC charging electronics 60 connected to battery bank 50 and supported by mobile platform 20, and at least one DC to DC electronic charging port 70 supported by mobile platform 20 and configured to connect to charging port 90 of electric vehicle 18. Mobile charging system 15 may include a second DC to DC electronic charging port 75 supported by mobile platform 20 and configured to connect to charging port 91 of electric vehicle 18.

In this embodiment, mobile platform 20 comprises a mobile trailer that is configured to be readily pulled from site to site by a truck or tractor. In this embodiment, trailer 20 is a conventional trailer about fifty-five feet long and about ten feet wide. Trailer 20 has multiple wheels and connects to a conventional truck or tractor so it can be easily hauled from location to location on existing road systems. Trailer 20 may therefore be moved so that it is in close proximity to the electric vehicles that need to be periodically charged, such as a work site.

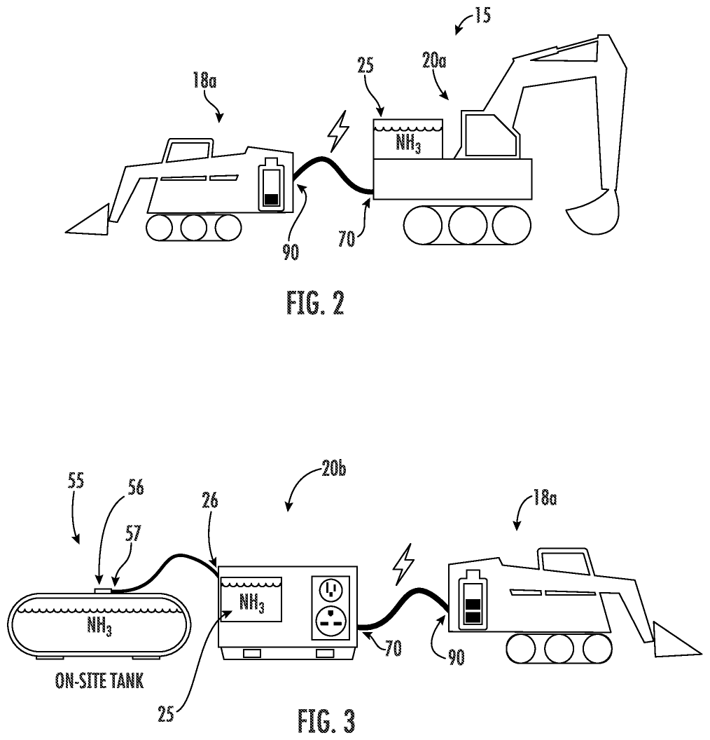

Other types of mobile platforms that can be readily movable may be used as alternatives. For example, FIG. 2 shows a tracked excavator mobile platform 20a and FIG. 3 shows a skidded mobile platform 20b. As shown, mobile platform 20a also functions as an electric construction vehicle having an excavation tool. Mobile platform 20b is a self-contained mobile unit supported on parallel skids that allow it to be readily pulled from site to site by a truck or the like. Mobile platform 20b may also comprise a base having openings for receiving forks of a forklift such that platform 20b may be readily lifted and transported from site to site by a forklift. Other alternatives for the mobile platform may include, without limitation, a truck chassis, a railway car and a detachable container or pod.

Trailer 20 may include a vibration dampening support structure and separation walls between different components of system 15. Trailer 20 may also include a power supply chamber housing an electric generator that is connected to and powers the components of system 15. A supplemental power source, such as a battery connected to solar panels on the roof of trailer 20, may be provided to augment power supply for the components of system 15.

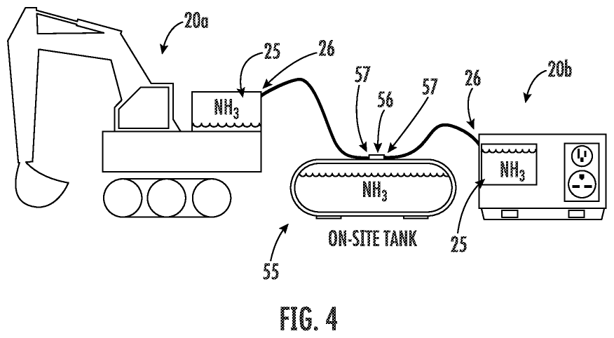

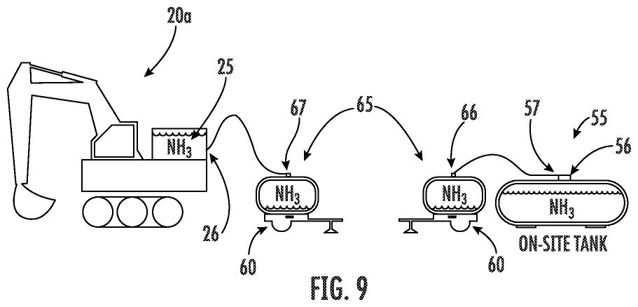

In this embodiment, mobile platform 20 supports liquid ammonia bulk storage tank 25. Storage tank 25 is configured to store liquid ammonia (NH₃) and can be periodically filled by refueling truck 16, for example, via inlet 26. Alternatively, and as shown in FIGS. 3 and 4, storage tank 25 may be of a smaller capacity that may be more regularly filled from a larger on-site bulk liquid ammonia storage tank 55 that is periodically filled by refueling truck 16 via inlet 56. As shown in FIG. 3, mobile platform 20b may be positioned next to bulk storage tank 55 and storage tank 25 in platform 20b may be connected to and filled directly from bulk tank 55 via a fluid conduit between outlet 57 of bulk tank 55 and inlet 26 of mobile tank 25. As a further alternative, and as shown in FIG. 9, intermediate mobile refueling transport 60 supporting refueling ammonia storage tank 65 may be used to transport liquid ammonia from on-site bulk liquid ammonia storage tank 55 to on-site mobile platform 20a, for example, rather than having to move mobile platform 20a next to bulk storage tank 55 each time tank 25 of mobile platform 20a is low on liquid ammonia and needs to be filled. As shown in FIG. 9, storage tank 25 may be of a smaller capacity that may be more regularly filled from an equal or larger intermediate mobile liquid ammonia storage tank 65 that is in turn periodically filled from larger on-site bulk liquid ammonia storage tank 55. Thus, storage tank 65 of mobile transport 60 may be of a smaller capacity than bulk tank 55 that is filled from larger on-site bulk liquid ammonia storage tank 55 via inlet 66. Mobile refueling transport 60 may be positioned next to bulk storage tank 55 and storage tank 65 on transport 60 may be connected to and filled from bulk tank 55 via a fluid conduit between outlet 57 of bulk tank 55 and inlet 66 of refueling tank 65 of transport 60. Transport 60 may then be readily moved from next to bulk tank 55 to a new position next to mobile platform 20a. With transport 60 positioned next to mobile platform 20a, storage tank 25 in platform 20a may be connected to intermediate transport tank 65 via a fluid conduit between outlet 67 of intermediate tank 65 and inlet 26 of mobile tank 25. Thus, breaks in the operation of mobile platform 20a as an electric construction vehicle may be reduced as no time is needed to move construction vehicle 20a back and forth from bulk tank 55 to refuel.

In this embodiment, fuel cell system 15 includes ammonia cracker or hydrogen generator 30 and hydrogen fuel cell 40. Ammonia fuel tank 25 is connected to ammonia cracker 30 on mobile platform 20. Ammonia cracker 30 takes liquid ammonia from tank 25 and dissociates the ammonia into hydrogen gas and nitrogen. The process may be performed at increased temperature in the presence of a catalyst.

Fuel cell 40 is an electrochemical cell that generally converts the chemical energy of a fuel and an oxidizing agent into electricity through a pair of redox reactions. Two chemical reactions occur at the interfaces of an anode, an electrolyte and a cathode and the net result of the two reactions is that fuel is consumed, water or carbon dioxide is created, and an electric current is created. In this embodiment, hydrogen fuel cell 40 converts hydrogen from ammonia cracker 30 into electrical power. Hydrogen fuel cell 40 uses the chemical energy of the hydrogen from ammonia cracker 30 to cleanly and efficiently produce electricity that is delivered to battery bank 50. To deliver the desired amount of energy, fuel cells may be combined in series in a fuel cell stack, and the fuel cell stacks may be combined in one or more fuel cell columns.

Battery bank 50 stores the power generated from fuel cell 40. In this embodiment, battery bank 50 comprises a number of batteries or individual battery cells. They may be configured in series, parallel or a mixture of both to deliver the desired voltage, capacity, or power density. Several types of batteries can be used for this application. The electric storage may also include a supercapacitor or ultracapacitor, or a bank of ultracapacitors.

In this embodiment, charging electronics 60 comprise direct current to direct current conditioning power electronics that output a regulated high voltage. Charging ports 70 and 75 comprise electric vehicle charge cables in at least a low power output (Level 2 Charging) and preferably in a high power output (Level 3 Charging). Thus, charging electronics 60 and charging ports 70 and 75 are configured to provide at least Level 2 charging and preferably Level 3 or DC Fast Charging (DCFC) to connected electric vehicle 18. As shown, in this embodiment platform 20 includes both port 75, which for example may provide an overnight charge (such as about 6-10 hours of charging) at Level 2, and port 70, which for example may provide a lunch break charge (such as about 15 minutes to 1 hour of charging) at Level 3. Charging electronics 60 regulate the DC electricity generated from fuel cell stack 40 and stored in battery bank 50 and uses battery bank 50 for the DC fast charging demand of port 70. In addition to or as an alternative to cable or corded charging, the system could use electromagnetic induction to provide inductive or wireless electric charging to electric vehicle 18.

As shown, various electric vehicles 18 may be charged via system 15. For example, and as shown in FIGS. 2 and 3, the electric vehicle may be an electric mobile machine or construction vehicle, such as electric skid steer loader 18a. Other electric construction vehicles may also be charged via mobile charging system 15, including without limitation electric backhoes, excavators, bulldozers, and dump trucks.

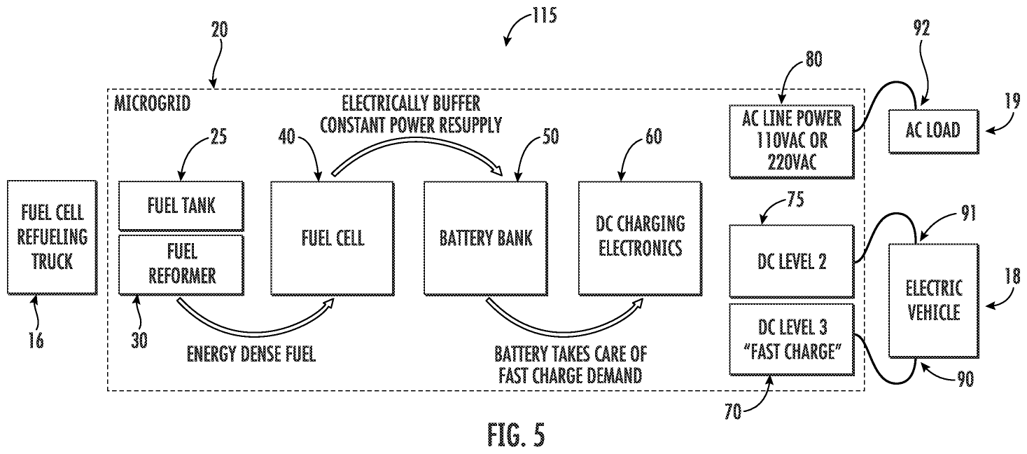

FIG. 5 shows second embodiment mobile charging system 115. Mobile system 115 is generally the same a mobile system 15 described above, having mobile platform 20 configured to be readily moved from a first location to a second location, liquid ammonia fuel storage tank 25 having fuel inlet 26 and supported by mobile platform 20, ammonia cracker 30 connected to ammonia fuel storage 25 and supported by mobile platform 20, hydrogen fuel cell 40 connected to ammonia cracker 30 and supported by mobile platform 20, battery bank 50 connected to hydrogen fuel cell 40 and supported by mobile platform 20, DC charging electronics 60 connected to battery 50 and supported by mobile platform 20, and at least one DC to DC electronic charging port 70 supported by mobile platform 20 and configured to connect to charging port 90 of electric vehicle 18. However, system 115 also includes charging electronics configured to provide AC on demand power and at least one AC to AC electronic port 80 supported by mobile platform 20 and configured to connect to power port 92 of AC load 19.

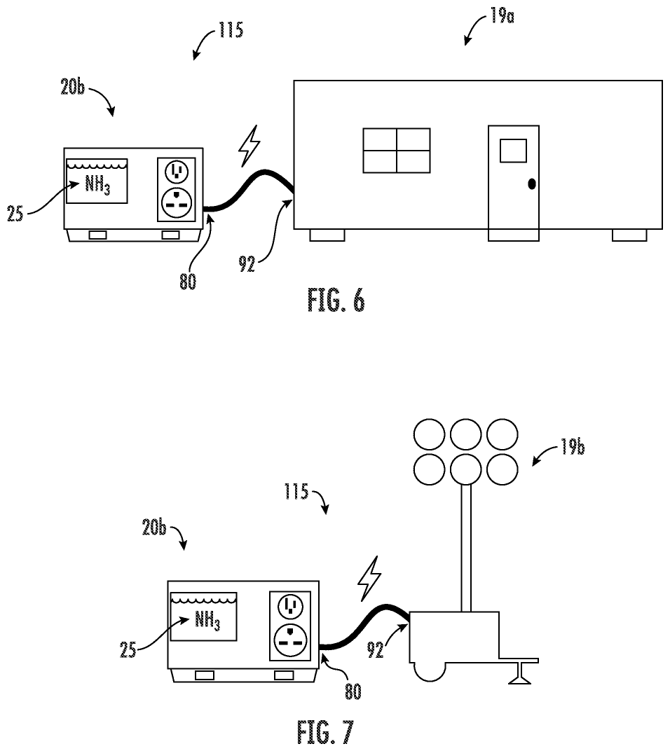

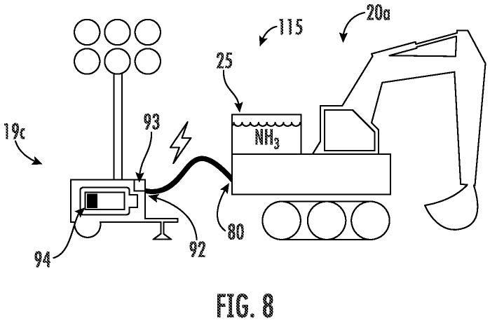

Various AC loads may be powered via mobile charging system 115. As shown in FIG. 6 for example, AC load 19 may comprise AC powered jobsite construction office trailer 19a having AC power input 92, and AC power line 80 of mobile platform 20b may be connected to AC input 92 of office trailer 19a for operational power. As shown in FIG. 7 for example, AC load 19 may comprise portable AC powered light tower 19b having AC power input 92, and AC power line 80 of mobile platform 20b may be connected to AC input 92 of light tower 19b for operational power. As shown in FIG. 8 for example, AC load 19 may comprise portable battery powered light tower 19c having an onboard charger and AC power input 92. In this embodiment, AC power line 80 of mobile platform 20a may be connected to AC input 92 and onboard AC-DC converter 93 to charge onboard battery 94, which it in turn provides operational power to light tower 19c. Other AC loads may also be powered via mobile charging system 115, including without limitation welding machines and power tools.

It should be appreciated that certain features of the system, which are, for clarity, described in the context of separate embodiments, may also be provided in combination in a single embodiment. Conversely, various features, which are, for brevity, described in the context of a single embodiment, may also be provided separately or in any suitable combination. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

What is claimed is:

1. A mobile charging system comprising:
a mobile platform configured to be readily moved from a first location to a second location;
an ammonia storage tank having a fuel inlet and supported by the mobile platform;
an ammonia cracker connected to the storage tank and supported by the mobile platform;
a hydrogen fuel cell connected to the ammonia cracker and supported by the mobile platform;
an electric storage connected to the hydrogen fuel cell and supported by the mobile platform;
charging electronics connected to the electric storage and supported by the mobile platform; and
at least one DC to DC electronic charging port supported by the mobile platform and configured to connect to a charging port of an electric vehicle.

2. The mobile charging system set forth in claim 1, wherein said electric storage comprises a battery.

3. The mobile charging system set forth in claim 1, wherein said charging electronics are configured to provide DC Level 3 charging.

4. The mobile charging system set forth in claim 1, wherein said charging electronics are configured to provide AC power and comprising at least one AC to AC electronic port supported by the mobile platform and configured to connect to the power port of an AC load.

5. The mobile charging system set forth in claim 4, wherein said AC load is selected from a group consisting of an office trailer, a welding machine, a power tool, a lighting device, and a converter to a battery.

6. The mobile charging system set forth in claim 1, wherein said mobile platform is selected from a group consisting of a trailer, a truck chassis, a flatbed, a railway car, a skid platform, and a detachable pod.

7. The mobile charging system set forth in claim 1, wherein said mobile platform comprises a construction vehicle.

8. The mobile charging system set forth in claim 7, wherein said construction vehicle is selected from a group consisting of a backhoe, an excavator, a bulldozer, a skid steer loader, and a dump truck.

9. The mobile charging system set forth in claim 1, wherein said electric vehicle comprises an electric mobile machine.

10. The mobile charging system set forth in claim 9, wherein said electric mobile machine is selected from a group consisting of a backhoe, an excavator, a bulldozer, a skid steer loader, and a dump truck.

11. The mobile charging system set forth in claim 1, comprising a bulk ammonia storage tank separate from said ammonia storage tank supported by the mobile platform, and the bulk ammonia storage tank having a bulk fuel inlet and a bulk fuel outlet configured to connect to said fuel inlet of said ammonia storage tank supported by said mobile platform.

12. The mobile charging system set forth in claim 11, comprising:
a mobile refueling platform configured to be readily moved from a first location to a second location;
a mobile refueling ammonia storage tank supported by the mobile refueling platform;
said mobile refueling ammonia storage tank separate from both said ammonia storage tank supported by the mobile platform and said bulk ammonia storage tank; and
said mobile refueling ammonia storage tank having a refueling fuel inlet configured to connect to said bulk fuel outlet of said bulk ammonia storage tank and a refueling fuel outlet configured to connect to said fuel inlet of said ammonia storage tank supported by said mobile platform.
